(19) United States
(12) Patent Application Publication
(10) Pub. No.: US 2006/0036013 A1
(43) Pub. Date: Feb. 16, 2006

(54) Side-chain-modified copolymer waxes

(76) Inventor: Franz-Leo Heinrichs, Gablingen (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/516,929

(22) PCT Filed: May 30, 2003
(86) PCT No.: PCT/EP03/05671

§ 371 Date: Jun. 13, 2005

(30) Foreign Application Priority Data
Jun. 8, 2002 (DE) 10225652.7

(51) Int. Cl. C08K 5/01

(52) U.S. Cl. 524/487

(57) ABSTRACT

The invention relates to side-chain-modified copolymer waxes consisting of long-chain olefins, acrylic acid esters, acrylic acid and/or acrylic acid amides, said waxes being characterised in that they are produced from wax-like copolymers of long-chain α-olefins comprising between 18 and 60 C atoms, acrylic acid methyl esters, acrylic acid and/or acrylic acid amides, the carboxyl functionality thereof having been modified by chemical reaction with nucleophilic constituents. The invention also relates to a method for producing such copolymer waxes and to the use of the same.

The invention relates to side-chain-modified copolymer waxes composed of long-chain olefins, of acrylic esters, acrylic acid, and/or of acrylamides, to a process for their preparation, and also to their use.

Copolymers with varying proportion of ethylene and acrylic acid are widely used. They are characterized by a high proportion of linear hydrocarbon and by the acid function derived from the acrylic acid. Alongside ethylene, use is also made of other short-chain olefins and acrylic esters. Since these reaction products are preferably plastics-like polymers which have only limited accessibility to subsequent chemical reaction, the corresponding acrylic acid derivatives (such as esters or amides) have hitherto been used directly for the modification of the side chains.

For example, U.S. Pat. No. 4,413,096 describes copolymers composed of ethylene and of acrylic esters derived from 2,2,6,6-tetramethylpiperidinol, their functionality enabling them to be used as light stabilizers.

DE 41 39 601 A1 describes copolymers composed of long-chain olefins with acrylic acid and methyl acrylate. As a result of the choice of the olefins, these products exhibit markedly waxy character. The side-chain functionality is limited to methyl or ethyl esters of acrylic acid.

It is desirable to find products which have waxy character but have an additional functionality in their side chains. It is known that products of this type can be prepared by copolymerizing long-chain olefins with the correspondingly modified acrylic acid derivatives. However, a number of disadvantages are attached to these processes. For example, acrylic acid derivatives of long-chain alcohols, of fluorinated alcohols, or of amines, are very expensive and complicated to prepare and purify. Furthermore, amine-containing derivatives undergo alteration in the presence of peroxides or of other free-radical initiators for the polymerization reaction, preventing preparation of the desired products. Other modified acrylic acid derivatives are very reluctant to form adducts with the respective olefin, or fail entirely to do so without undergoing alteration.

It is therefore an object of the present invention to provide copolymer waxes which can be modified in a particularly simple manner and which eliminate the disadvantages of the prior art. A further intention was to provide access or, respectively, easy access to products which hitherto have been impossible or very difficult to prepare.

This object is achieved via side-chain-modified copolymer waxes of the type mentioned at the outset, which are prepared from waxy copolymers of long-chain α-olefins having from 18 to 60 carbon atoms, methyl acrylate, acrylic acid, and/or from acrylamides whose carboxy functionality has been modified via chemical reaction with nucleophilic components.

The nucleophilic components are preferably long-chain alcohols, perfluoroalkyl alcohols, short-chain amines, long-chain amines, and/or amino alcohols.

The long-chain alcohols are preferably tallow fatty alcohol, coconut fatty alcohol, oxo alcohols, and/or Guerbet alcohol.

The perfluoro alcohols are preferably C₈-C₁₈-perfluoroalkylpropanol and distillate cuts of these alcohols.

Distillate cut: distillation is a physical separation method in which the different boiling points of the constituents (components) of a mixture are utilized for separation. In its simplest variant, the liquid dripping down from the condenser is collected successively and separately in small fractions. This procedure is continued until most of the original volume has been distilled. A suitable method is then used to study the composition of the individual fractions. These fractions are also termed distillation cut (distillate cut). The composition of these fractions depends on the boiling point differences of the individual components and on the distillation conditions.

The short-chain amines are preferably butylamine, dimethylaminopropyl-amine, diethylaminoethanol, tetramethylpiperidinol and/or triacetone-diamine.

The long-chain amines are preferably octylamine, decylamine, dodecylamine, tallow fatty amine, coconut fatty amine, didecylamine, and/or cyclohexylamine. In industry, long-chain compounds are usually those having alkyl chain lengths >C8, for example those found in wetting agents, surfactants, and waxes. This term may include not only linear aliphatic substances but also branched aliphatic and cycloaliphatic substances.

The alkanolamines are preferably diethylaminoethanol, 2,2,6,6-tetra-methylpiperidinol, N-methyl-2,2,6,6-tetramethylpiperidinol, N-acetyl-2,2,6,6-tetramethylpiperidinol and/or 2,2,6,6-tetramethylpiperidinol N-oxide.

The present object is also achieved via a process for the production of side-chain-modified copolymer waxes which comprises first reacting long-chain alpha-olefins having from 18 to 60 carbon atoms with acrylic esters, acrylic acid, and/or with acrylamides, to give long-chain copolymer waxes, and then reacting these with nucleophilic components to give the side-chain-modified copolymer waxes.

The nucleophilic components which can be used for the abovementioned process are preferably long-chain alcohols, such as tallow fatty alcohol, coconut fatty alcohol, oxo alcohols, and/or Guerbet alcohol; perfluoroalkyl alcohol, such as C₈-C₁₈-perfluoroalkylpropanol, and distillate cuts of these alcohols; short-chain amines, such as butylamine, dimethylamino-propylamine, diethylaminoethanol, tetramethylpiperidinol, and/or triacetonediamine; long-chain amines, such as octylamine, decylamine, dodecylamine, tallow fatty amine, coconut fatty amine, didecylamine, and/or cyclohexylamine, and/or alkanolamines, such as diethylaminoethanol, 2,2,6,6-tetramethylpiperidinol, N-methyl-2,2,6,6-tetramethylpiperidinol, N-acetyl-2,2,6,6-tetramethylpiperidinol and/or 2,2,6,6-tetramethylpiperidinol N-oxide.

The invention also provides the use of the inventive side-chain-modified copolymer waxes in emulsified form for coatings and water-repellency.

The side-chain-modified copolymer waxes are also used in micronized form as matting agents, slip agents, antiscratch agents, and for improving chemicals resistance.

They are likewise used in the form of lubricants, dispersing agent, or light stabilizer, as processing aids for plastics.

The term carboxy functionality is explained as follows:

Copolymerization of olefins with acrylic acid and with acrylic esters gives polymers which contain carboxylic acid functions and contain ester functions.

These functions are usually termed carboxy functions. In the raw materials, it is the functionality of the acid COOH and of the methyl ester COOCH₃ that are altered in the inventive reaction products to give COOR and CONR¹R². R here are alkyl groups other than CH₃.

The invention is explained via the following examples. The determination methods used were as follows:

| | |
|---|---|
| Drop point | DIN 51801/2, ASTM D 127 |
| Softening point | DIN EN 1427, ASTM E 28, ASTM D 36 |
| Acid number | DIN 53402, ASTM 1386 |
| Saponification number | DIN 53401 ASTM 1387 |
| Density | DIN 53479 ASTM D 1298, D 1505 |
| Viscosity | DIN 51562 DIN 53018 |
| Hydroxy number | OHZ DGF M IV 6 (57) |

### PREPARATION EXAMPLES

### Comparative Example 1

### Copolymer Composed of C₃₀-α-olefins with acrylic acid/methyl acrylate

Mixture:

| | |
|---|---|
| C₃₀-α-olefin | 1 mol |
| Acrylic acid | 0.3 mol |
| Methyl acrylate | 2.5 mol |
| Di-tert-butyl peroxide | 5% by weight, based on methyl acrylate |

Process:

The olefin is melted at 100° C., and the mixture is heated to 150° C., and then di-tert-butyl peroxide, methyl acrylate, and acrylic acid are metered in, and stirring is continued for 5 hours. The free monomers are removed by distillation.

| | |
|---|---|
| Acid number: | 5 |
| Viscosity number (cm³/g): | 149 |
| Drop point (° C.): | 76.5 |
| Molecular weight: | about 3000 |

### Comparative Example 2

### Copolymer Composed of C₂₀/C₂₂-α-olefin with methyl acrylate

Mixture:

| | |
|---|---|
| C₂₀/C₂₂-α-olefin | 1 mol |
| Acrylic acid | 0.1 mol |
| Methyl acrylate | 1.5 mol |
| Di-tert-butyl peroxide | 5% by weight, based on methyl acrylate |

Process:

The olefin is melted at 100° C., and the mixture is heated to 150° C., and then di-tert-butyl peroxide, methyl acrylate, and acrylic acid are metered in, and stirring is continued for 5 hours. The free monomers are removed by distillation.

| | |
|---|---|
| Acid number: | 15 |
| Viscosity number (cm³/g): | 180 |
| Drop point (° C.): | 56.5 |
| Molecular weight: | about 5000 |

### Comparative Example 3

### Copolymer composed of C₃₀-α-olefin with methyl acrylate

Mixture:

| | |
|---|---|
| C₃₀-α-olefin | 1 mol |
| Methyl acrylate | 1.5 mol |
| Di-tert-butyl peroxide | 5% by weight, based on methyl acrylate |

Process:

The olefin is melted at 100° C., and the mixture is heated to 150° C., and then di-tert-butyl peroxide and methyl acrylate are metered in, and stirring is continued for 3 hours. The free monomers are removed by distillation.

| | |
|---|---|
| Acid number: | 1 |
| Viscosity number (cm³/g): | 101 |
| Drop point (° C.): | 71.3 |
| Molecular weight: | about 3500 |

### Comparative Example 4

### Copolymer Composed of C₁₈-α-olefin with methyl acrylate

Mixture:

| | |
|---|---|
| C₁₈-α-olefin | 1 mol |
| Methyl acrylate | 2.5 mol |
| Di-tert-butyl peroxide | 5% by weight, based on methyl acrylate |

Process:

The olefin is melted at 100° C., and the mixture is heated to 150° C., and then di-tert-butyl peroxide and methyl acrylate are metered in, and stirring is continued for 5 hours. The free monomers are removed by distillation.

| | |
|---|---|
| Acid number: | 1 |
| Viscosity number (cm³/g): | 385 |
| Drop point (° C.): | 46.5 |
| Molecular weight: | about 5000 |
| Melt viscosity (160° C.): | 2060 mPas |

### INVENTIVE EXAMPLES

### Inventive Example 1

### Copolymer Wax Modified with Tallow Fatty Alcohol Side Chains

| | |
|---|---|
| Copolymer of comparative | 1 mol, |
| example 3 | |
| Tallow fatty alcohol | 0.5 mol, |
| Na methoxide | 0.3% by weight, based on mixture |

Process:

The copolymer is melted at 100° C., treated with the catalyst (Na methoxide) and with the alcohol component (tallow fatty alcohol), and heated to 180° C.

The mixture is stirred at this temperature for 7 hours, and methanol liberated is removed by distillation. Vacuum is then applied in order to remove residues of methanol and other alcohols by distillation, phosphoric acid is used for neutralization, and the mixture is cooled to 120° C. and filtered.

| | |
|---|---|
| Acid number: | 10 |
| Viscosity number (cm³/g): | 80 |
| Drop point (° C.): | 74.3 |

The product is a suitable lubricant for PVC with pale color and polarity adjustable by way of the degree of exchange, and is also a suitable dispersion aid for pigments.

### Inventive Example 2

### Copolymer Wax Modified with perfluoroalkylpropanol (C₁₂-C₁₄) Side Chains

| | | |
|---|---|---|
| Copolymer of comparative | 1 | mol, |
| example 1 | | |
| C₁₂-C₁₄-perfluoroalkylpropanol | 0.12 | mol, |
| Na methoxide | 0.3% | by weight, based on mixture |

Process:

The copolymer is melted at 100° C., treated with the catalyst (Na methoxide) and with the alcohol component (C₁₂-C₁₄-perfluoroalkylpropanol), and heated to 180° C. The mixture is stirred at this temperature for 7 hours, and methanol liberated is removed by distillation. Vacuum is then applied in order to remove residues of methanol and other alcohols by distillation, phosphoric acid is used for neutralization, and the mixture is cooled to 120° C. and filtered.

| | |
|---|---|
| Acid number: | 10 |
| Viscosity number (cm³/g): | 145 |
| Drop point (° C.): | 70.3 |
| Melt viscosity (160 l): | 572 mPas |

The product is suitable for the preparation of emulsions with water repellency, car polishes, textile emulsions, and also for the preparation of micronizates with about 10 micron particle size, and for providing gloss and slip in aqueous and solvent-based coatings.

Emulsion Formulation:

| | |
|---|---|
| Experimental wax of inventive example 3 | 5.0 g |
| ® Licowax KSL | 15.0 g |
| Wax emulsifier 4106 | 3.0 g |
| Olein | 1.0 g |
| KOH | 0.4 g |
| Water | 75.6 g |

Coating Formulation:

| | |
|---|---|
| KPU coating | 98.0 g |
| Wax of example 2, micronized | 2.0 g |

Gloss at 60° C.

55 units, compared with 140 without addition=good matting

Sliding friction with 0.914 kg load

0.16 g, compared with 0.35 g without addition=good scuff protection

Water and alcohol resistance

No solvation, compared with discernible solvation without addition=good water and alcohol resistance

### Inventive Example 3

### Copolymer Wax Modified with triacetonediamine Side Chains

| | | |
|---|---|---|
| Copolymer of comparative example 1 | 1 | mol |
| Triacetonediamine | 0.25 | mol |
| ® Fascat 4102 | 0.2% | by weight based on mixture |

Process:

The copolymer is melted at 100° C., treated with the catalyst (®Fascat 4102) and with the amine component, and heated to 190° C. The mixture is stirred at this temperature for 7 hours, and methanol liberated is removed by distillation. Vacuum is then applied in order to remove residues of methanol and amine by distillation, and the mixture is cooled to 120° C. and filtered.

| | |
|---|---|
| Acid number: | 10 |
| Viscosity number (cm³/g): | 145 |
| Drop point (° C.): | 70.3 |
| Melt viscosity (100° C.): | 572 mPas |

Recommended Application:

Light stabilizer for very thin polypropylene applications, tape products with reduced water adhesion.

Performance Test

water carry-over effect=wco (quantitative evaluation of water absorption during the production process, the method of evaluation using a scale from 1 to 5)

*Mosten 58.412 polypropylene+0.15 parts of auxiliary

*(Czech polypropylene)

extruded to give tapes with film thickness 100 microns

Extruder: 270° C., 92 rpm, 4 m/min

| | |
|---|---|
| ® Chimasorb 944 | wco value 5 |
| ® Hostavin N 24 | wco value 4 |
| ® Tunuvin 622 | wco value 2 |
| Experimental product according to example 3 | wco value 0 |

A scale from 0 to 5 was used for evaluation, where 0=no water absorption and 1-5 is rising water absorption, industrial use being assessed as impossible from 3 upward.

### Inventive Example 4

### Copolymer Wax Side-Chain-Modified with triacetonediamine

| | | |
|---|---|---|
| Copolymer of comparative example 4 | 1 | mol |
| Triacetonediamine | 0.5 | mol |
| ® Fascat 4102 | 0.2% | by weight based on mixture |

Process:

The copolymer is melted at 100° C., treated with the catalyst (®Fascat 4102) and with the amine component, and heated to 190° C. The mixture is stirred at this temperature for 7 hours, and methanol liberated is removed by distillation. Vacuum is then applied in order to remove residues of methanol and amine by distillation, and the mixture is cooled to 150° C. and filtered.

| | |
|---|---|
| Acid number: | 18 |
| Viscosity number (cm³/g): | 136 |
| Drop point (° C.): | 120° C. |
| Alkali number: | 67.8 |
| Melt viscosity (170° C.): | 572 mPas |

Recommended Application:

Processing aid for polyolefins and pigment dispersion with light-stabilizer action.

Performance Test

0.1 mm films pressed from P P with 0.15% of active substance or active substance equivalent

| | |
|---|---|
| Active substance | Time to decomposition in hours |

| | |
|---|---|
| ® Hostavin N20 | 2100 |
| ® Hostavin N30 | 2000 |
| ® Cimasorb 944 | 2000 |
| ® Tinuvin 770 | 1400 |
| Experimental product of inventive | 2100 |
| example 4 | |

### Inventive Example 5

### Copolymer Wax Side-Chain-Modified with 2,2,6,6-tetramethylpiperidinol

| | |
|---|---|
| Copolymer of comparative example 1 | 1 mol |
| 2,2,6,6-tetramethylpiperidinol | 0.6 mol |
| ® Fascat 4102 | 0.2% by weight based on mixture |

Process:

The copolymer is melted at 100° C., treated with the catalyst and with the amine component, and heated to 190° C. The mixture is stirred at this temperature for 7 hours, and methanol liberated is removed by distillation. Vacuum is then applied in order to remove residues of methanol and amine by distillation, and the mixture is cooled to 150° C. and filtered.

| | |
|---|---|
| Acid number: | 8 |
| Viscosity number (cm³/g): | 136 |
| Drop point (° C.): | 68 |
| Alkali number: | 21 |
| Melt viscosity (170° C.): | 76 mPas |

The product is used as processing aid in polypropylene with light-stabilizer action.

### Inventive Example 6

### Copolymer Wax Side-Chain-Modified with triacetonediamine

| | |
|---|---|
| Copolymer of comparative example 1 | 1 mol |
| Triacetonediamine | 0.6 mol |
| ® Fascat 4102 | 0.2% by weight based on mixture |

The copolymer is melted at 100° C., treated with the catalyst and with the amine component, and heated to 190° C. The mixture is stirred at this temperature for 7 hours, and methanol liberated is removed by distillation. Vacuum is then applied in order to remove residues of methanol and amine by distillation, and the mixture is cooled to 150° C. and filtered.

| | |
|---|---|
| Acid number: | 16 |
| Viscosity number (cm³/g): | 82 |
| Drop point (° C.): | 113 |
| Alkali number: | 67.8 |
| Melt viscosity (170° C.): | 572 mPas |

### Inventive Example 7

### Copolymer Wax Side-Chain-Modified with diethylaminopropylamine

| | |
|---|---|
| Copolymer of comparative example 4 | 1 mol |
| Diethylaminopropylamine | 0.6 mol |
| ® Fascat 4102 | 0.2% by weight based on mixture |

The copolymer is melted at 100° C., treated with the catalyst and with the amine component, and heated to 190° C. The mixture is stirred at this temperature for 7 hours, and methanol liberated is removed by distillation. Vacuum is then applied in order to remove residues of methanol and amine by distillation, and the mixture is cooled to 150° C. and filtered.

| | |
|---|---|
| Acid number: | 5 |
| Viscosity number (cm³/g): | 82 |
| Drop point (° C.): | 118 |
| Alkali number: | 74 |
| Melt viscosity (170° C.): | 572 mPas |

Recommended Application:

Cationically emulsifiable wax for water-resistant coatings, car polishes, floorcoverings, crop protection

Formulation:

| | |
|---|---|
| Experimental wax of inventive example 7 | 22.5 g |
| Wax emulsifier | 2.25 g |
| Acetic acid | 1.5 g |
| Water | 73.75 g |

### Inventive Example 8

### Copolymer Wax Side-Chain-Modified with octylamine

| | |
|---|---|
| Copolymer of comparative example 1 | 1 mol |
| Octylamine | 0.6 mol |
| ® Fascat 4102 | 0.2% by weight based on mixture |

The copolymer is melted at 100° C., treated with the catalyst and with the amine component, and heated to 190° C. The mixture is stirred at this temperature for 7 hours, and methanol liberated is removed by distillation. Vacuum is then applied in order to remove residues of methanol and amine by distillation, and the mixture is cooled to 150° C. and filtered.

| | |
|---|---|
| Acid number: | 16 |
| Viscosity number (cm³/g): | 45 |
| Drop point (° C.): | 95 |
| Alkali number: | 3 |
| Melt viscosity (170° C.): | 360 mPas |

Dispersing agent in engineering thermoplastics

### SUMMARY OF INVENTIVE EXAMPLES

Copolymers available in the prior art are in essence based on reactions of ethylene or of long-chain olefins with acrylic acid or with acrylic esters. In the case of ethylene, these are plastics which cannot be further modified, and in the case of the long-chain olefins they are waxy compounds. The prior art achieves functionality via incorporation of appropriate acrylic acid derivatives, e.g. stearyl acrylate, 2,2,6,6-tetramethylpiperidinyl acrylate, perfluoroalkyl acrylate, N-octylacrylamide, etc.

A more cost-effective method giving easier control of functionality is the chemical modification of waxy copolymers composed of long-chain olefins and acrylic acid compounds as claimed in the present invention. Suitable conduct of the reaction here can react to the acrylic acid compound with the desired functional components. This permits preparation of waxy polymers (copolymer waxes) for a wide variety of applications.

1. A side-chain-modified copolymer wax composed of a long-chain olefin, and at least one of acrylic esters, acrylic acid, or acrylamides, wherein the copolymer wax is prepared from waxy copolymers of long-chain α-olefins having from 18 to 60 carbon atoms, and at least one of methyl acrylate, acrylic acid, or acrylamides and wherein the carboxy functionality of the copolymer wax has been modified via chemical reaction with at least one nucleophilic component.

2. The side-chain-modified copolymer wax as claimed in claim 1, wherein the at least one nucleophilic component is selected from the group consisting of long-chain alcohols, perfluoroalkyl alcohols, short-chain amines, long-chain amines, and amino alcohols.

3. The side-chain-modified copolymer wax as claimed in claim 2, wherein the long-chain alcohols are selected from the group consisting of tallow fatty alcohol, coconut fatty alcohol, oxo alcohols, and Guerbet alcohol.

4. The side-chain-modified copolymer wax as claimed in claim 2, wherein the perfluoroalkyl alcohols are C₈-C₁₈-perfluoroalkylpropanol or distillate cuts thereof.

5. The side-chain-modified copolymer wax as claimed in claim 2, wherein the short-chain amines are compounds such selected from the group consisting of butylamine, dimethylaminopropylamine, diethylaminoethanol, tetramethylpiperidinol, and triacetonediamine.

6. The side-chain-modified copolymer wax as claimed in claim 2, wherein the long-chain amines are selected from the group consisting of octylamine, decylamine, dodecylamine, tallow fatty amine, coconut fatty amine, didecylamine, and cyclohexylamine.

7. The side-chain-modified copolymer wax as claimed in claim 2, wherein the amino alcohols are selected from the group consisting of diethylaminoethanol, 2,2,6,6-tetramethylpiperidinol, N-methyl-2,2,6,6-tetramethylpiperidinol, N-acetyl-2,2,6,6-tetramethylpiperidinol and 2,2,6,6-tetramethylpiperidinol N-oxide.

8. A process for the preparation of a side-chain-modified copolymer wax comprising the steps of reacting a long-chain α-olefin having from 18 to 60 carbon atoms with at least one of an acrylic ester, acrylic acid, or an acrylamide, to give a long-chain copolymer wax, and reacting the long-chain copolymer wax with at least one nucleophilic component to give the side-chain-modified copolymer wax.

9. The process as claimed in claim 8, wherein the at least one nucleophilic component is selected from the group consisting of long-chain alcohols, perfluoroalkyl alcohol, short-chain amines, long-chain amines, and alkanolamines.

10. A coating composition comprising a side-chain-modified copolymer wax as claimed in claim 1, wherein the side-chain-modified copolymer wax is in emulsified form.

11. A composition comprising a side-chain-modified copolymer wax as claimed in claim 1, wherein the side-chain-modified copolymer wax is in micronized form and wherein the composition is a matting agent, slip agent, antiscratch agent, or a composition to improve chemical resistance.

12. A plastics processing aid comprising a side-chain-modified copolymer wax as claimed in claim 1, wherein the processing aid is a lubricant, dispersing agent or a light stabilizer.

13. A side-chain-modified copolymer wax made in accordance with the process of claim 8.

14. The process as claimed in claim 9, wherein the long-chain alcohol is selected from the group consisting of tallow fatty alcohol, coconut fatty alcohol, oxo alcohols, and/or Guerbet alcohol.

15. The process as claimed in claim 9, wherein the perfluoroalkyl alcohol is C₈-C₁₈-perfluoroalkylpropanol, and distillate cuts thereof.

16. The process as claimed in claim 9, wherein the short chain amines are selected from the group consisting of butylamine, dimethylaminopropylamine, diethylaminoethanol, tetramethylpiperidinol, and triacetonediamine.

17. The process as claimed in claim 9, wherein the long-chain amines are selected from the group consisting of octylamine, decylamine, dodecylamine, tallow fatty amine, coconut fatty amine, didecylamine, cyclohexylamine and alkanolamines.

18. The process as claimed in claim 9, wherein the alkanolamines are selected from the group consisting of diethylaminoethanol, 2,2,6,6-tetramethylpiperidinol, N-methyl-2,2,6,6-tetramethylpiperidinol, N-acetyl-2,2,6,6-tetramethylpiperidinol and 2,2,6,6-tetramethylpiperidinol N-oxide.

19. A water repellency compound comprising a side-chain-modified copolymer wax as claimed in claim 1, wherein the side-chain-modified copolymer wax is in emulsified form.
